(19) United States
(12) Patent Application Publication
(10) Pub. No.: US 2018/0077879 A1
(43) Pub. Date: Mar. 22, 2018

(54) Tree Processor Attachment

(71) Applicant: Axis Forestry Inc., Kamloops (CA)

(72) Inventors: Wayne Cochran, Kamloops (CA); Alex Willer, Kamloops (CA)

(73) Assignee: Axis Forestry Inc., Kamloops (CA)

(21) Appl. No.: 15/710,659

(22) Filed: Sep. 20, 2017

Related U.S. Application Data
(60) Provisional application No. 62/397,851, filed on Sep. 21, 2016.

(51) Int. Cl. A01G 23/095; B27B 1/00; A01G 23/099; A01G 23/091

(52) U.S. Cl. CPC A01G 23/095; A01G 23/091; A01G 23/099; B27B 1/007

(57) ABSTRACT

A saw bar clamping mechanism, length measuring mechanism, system for measuring the length of a tree stem, feed roller mechanism, pin retention mechanism, and a tree processor attachment comprising at least one of the mechanisms and/or system is provided. The saw bar mechanism simultaneously unclamps a saw bar and releases a saw chain for convenient removal. The length measuring mechanism comprises a measuring wheel operable to extend and retract perpendicularly to a tree stem. The feed roller mechanism includes first-side and second-side rollers, and a bearing having outer and inner sides, the bearing being rotatably coupled at its outer side to the first-side roller and rotatably coupled at its inner side to the second-side roller, the bearing making angular contact. The pin retention mechanism includes a two-part collar fitting into a groove with interference for locking a nut received by the collar.

### BACKGROUND OF THE INVENTION

### 1. Field of Invention

This invention relates to machinery used in the forestry industry and, in particular, to a tree processor attachment for forestry harvesters.

### 2. Description of Related Art

A forestry harvester or tree processor is used to harvest trees by felling, delimbing and bucking trees prior to transport of the cut logs to a saw mill or the like. Felling the tree involves removing the stem of the tree from the stump which remains in the ground. Delimbing involves removing branches from the stem of the fallen tree. Bucking involves cutting the tree stem into logs of desired lengths.

A conventional tree processor includes an excavator or other heavy forestry vehicle having a boom that carries a felling head or tree processor attachment.

The tree processor attachment, typically under the control of an operator located in the cab of the tree processor and powered hydraulically by the tree processor, is conventionally operable to grip a standing tree; saw the tree to separate the gripped stem from the stump that remains in the ground; feed the stem through the tree processor attachment while delimbing the stem; measure the length of the stem as it is fed through the tree processor attachment; stop feeding and cut the stem at selected lengths to produce cut-to-length logs; and repeat the process of measuring length while delimbing and cutting at desired lengths.

The tree processor attachment conventionally includes a chain saw for cutting the tree from the stump and for cutting the tree stem into logs. However, such conventional chain saws are often cumbersome and/or time consuming to remove from the tree processor attachment for replacement, cleaning or other maintenance.

The tree processor attachment conventionally includes a measuring wheel that is pivotally attached to a main body of the tree processor attachment, such that the measuring wheel swings out into position to measure tree stem length as the tree stem is fed through the tree processor attachment. However, contours of the tree stem affecting the pivotal extension of the measuring wheel can introduce side loads on the pivotable components, which can adversely affect the longevity and reliability of the tree processor attachment.

The tree processor attachment conventionally includes a pair of parallel, spaced apart feed rollers for feeding the tree stem through the tree processor attachment. However, contours of the tree stem can introduce side loads onto the conventional feed rollers that can adversely affect longevity and reliability of the feed rollers and the conventional tree processor attachment itself.

The tree processor attachment conventionally includes pins for rotatably coupling to the main body of the tree processor attachment various components such as feed rollers and delimbing arms. Each end of each pin is conventionally attached to the main body, such as at one or more flanges, by a threaded nut. However, such pin retention nut can loosen over time, thereby adversely affecting the reliability of the tree processor attachment.

An object of the invention is to address the above shortcomings.

### SUMMARY

The above shortcomings may be addressed by providing, in accordance with one aspect of the invention, an apparatus for processing trees when attached to a forestry vehicle. The apparatus may be a tree processor attachment. The apparatus includes a chain saw for cutting the trees.

The chain saw includes a saw bar, a chain and a saw bar clamping mechanism. The saw bar clamping mechanism may include a pair of clamping plates dimensioned for clamping the saw bar. The saw bar clamping mechanism may include a cam slidably coupled to the saw bar. The cam may be rotatable to a first cam position. The cam may be rotatable to a second cam position different from the first cam position. The cam may be dimensioned to cause the clamping plates to clamp the saw bar when the cam is at the first cam position. The cam may be dimensioned to cause the saw bar to extend when the cam is at the first cam position. The saw bar may be dimensioned to apply tension to the chain when the saw bar is extended. The cam may be dimensioned to cause the saw bar to apply tension to the chain when the cam is at the first cam position. The cam may be dimensioned to cause the clamping plates to unclamp the saw bar when the cam is at the second cam position. The cam may be dimensioned to permit the saw bar to retract when the cam is at the second cam position. The cam may be dimensioned to cause the saw bar to retract when the cam is at the second cam position.

The saw bar clamping mechanism may include a first lever attached to the cam. The first lever may be operable to rotate when the cam is rotated. The saw bar clamping mechanism may include a second lever attached between a main body of the apparatus and the first lever. The second lever may be rotatably attached to the main body. The second lever may be rotatably attached to the first lever. The second lever may be a resilient lever. The second lever may be operable to cause the saw bar to apply tension to the chain when the cam at its first cam position. The second lever may include a resilient member. The resilient member may be a spring. The second lever may include a tension-adjustment member. The tension-adjustment member may be attached to the second lever such that the tension-adjustment member abuts the resilient member. The tension-adjustment member may be a nut. The nut may be threadedly attached to the second lever. The tension-adjustment member may be operable to adjust the tension applied to the chain by the saw bar when the cam is at its first cam position. The nut may be dimensioned for adjusting the tension applied to the chain by the saw bar by threadedly moving the nut along the second lever.

The clamping plates may include first and second clamping plates. The first and second clamping plates may be dimensioned for permitting at least an end portion of the saw bar to fit between the first and second clamping plates. The first clamping plate may be fixed relative to the main body of the apparatus.

The second clamping plate may be operable to clamp the saw bar when the cam is at the first cam position. The cam may include first and second cam plates. The first and second cam plates may be disposed parallel to each other. The first cam plate may include a first-cam lobe facing the second cam plate. The second cam plate may include a second-cam lobe facing the first cam plate. The first and second cam plates may be dimensioned such that rotating the first cam plate aligns the first-cam lobe with the second-cam lobe of the second cam plate. The lever may be attached to the first cam plate for rotating the first cam plate. The second cam plate may include the second clamping plate. The second cam plate may be the second clamping plate.

The saw bar clamping mechanism may include a handle for actuating the second lever. The handle may be dimensioned for moving the second lever such that the cam moves between its first and second positions. The handle may be a removable handle.

The apparatus may be operable to grip a tree stem. The apparatus may be operable to grip the tree stem along a longitudinal axis. The apparatus may include gripping arms for gripping the tree stem. The longitudinal axis may be defined by the orientation of the gripping arms relative to the main body of the apparatus.

The apparatus may include a length measuring mechanism. The length measuring mechanism may be dimensioned to project from the main body of the apparatus in a direction substantially perpendicular to the longitudinal axis. The length measuring mechanism may include a measuring wheel rotatably coupled to a wheel support. The wheel support may be slidably coupled to a guide. The guide may include a pair of guide shafts. The guide shafts may be disposed on opposing ends of the measuring wheel. The guide may project from the main body of the apparatus. The guide may be dimensioned to project from the main body of the apparatus substantially perpendicular to the longitudinal axis. The length measuring mechanism may include a linear actuator for sliding the wheel support along the guide. The linear actuator may be operable to extend the wheel support outwardly from the main body of the apparatus. The linear actuator may be operable to slidably extend the wheel support. The linear actuator may be operable to retract the wheel support inwardly toward the main body of the apparatus. The linear actuator may be operable to slidably retract the wheel support. The linear actuator may include a hydraulic cylinder. The linear actuator may be operable to slidably retract the wheel support. The linear actuator may include a pair of hydraulic cylinders disposed at opposing ends of the measuring wheel. The linear actuator may be operable to cause the wheel support to extend outwardly from the main body of the apparatus in accordance with a pre-determined force. The linear actuator may be operable to cause the measuring wheel to extend outwardly from the main body of the apparatus in accordance with a pre-determined hydraulic actuation pressure. The length measuring mechanism may include an accumulator for absorbing hydraulic fluid so as to maintain substantially constant hydraulic pressure for extending outwardly the measuring wheel.

The apparatus may include a system for measuring the length of a tree stem. The system may include the length measuring mechanism. The system may include an encoder for producing a count of the number of rotations of the measuring wheel when the length measuring mechanism is extended. The encoder may be mounted to the wheel support. The system may include a computerized processor and a memory. The memory may contain codes of instructions for instructing the processor to determine a length in response to receiving the count from the encoder. The system may include a display for displaying the determined length.

The apparatus may include first and second feed rollers for feeding the tree stem through the apparatus. The first feed roller may be coupled to a hub of the apparatus. The second feed roller may be coupled to a hub of the apparatus. The first and second feed rollers may be disposed adjacent to each other so as to be in a non-contacting abutment relationship to each other.

The apparatus may include one or more pins, each pin having a groove adjacent an end of the pin, and a pin retention mechanism. The pin retention mechanism may include a two-part collar. Each collar part may include a first longitudinal section dimensioned for mating with the groove. The first longitudinal section may include a flattened portion for mating with a flattened of the groove. The first longitudinal section may be associated with a diameter that is less than the diameter of the groove so as to mate with interference. Each collar part may include a second longitudinal section dimensioned for mating with the end of the pin. The second longitudinal section may be associated with a diameter that is less than the diameter of the end of the pin so as to mate with interference. The pin retention mechanism may include a nut for threadedly engaging the collar when the collar is mated to the pin. The pin retention mechanism may include a protective cap dimensioned for being fastened to the end of the pin. The pin retention mechanism may include a fastener for fastening the protective cap onto the end of the pin.

In accordance with another aspect of the invention, there is provided a saw bar clamping mechanism for use in a chain saw having a saw bar and a chain, the saw bar clamping mechanism comprising: (a) a pair of clamping plates dimensioned for clamping the saw bar; (b) a cam having a first cam position in which the saw bar is clamped and applies tension to the chain, and having a second cam position in which the saw bar is unclamped such that tension on the chain is released. The saw bar clamping mechanism may include a resilient lever operable to cause the saw bar to apply the tension to the chain with substantially constant force when the cam is at its first cam position. The saw bar clamping mechanism may include a tension-adjustment member attached to the resilient lever for adjusting the tension applied by the saw bar when the cam is at its first cam position. The saw bar clamping mechanism may be operable for use in a tree processor attachment.

In accordance with another aspect of the invention, there is provided a length measuring mechanism for use in a tree processor attachment, the tree processor attachment being operable to grip a tree stem along a longitudinal axis defined by the tree processor attachment, the length measuring mechanism comprising: (a) a guide projecting from a main body of the tree processor attachment substantially perpendicular to the longitudinal axis; (b) a wheel support slidably coupled to the guide; and (c) a measuring wheel rotatably coupled to the wheel support. The length measuring mechanism may include a linear actuator for controlling the extent to which the wheel support is slidably extended along the guide.

In accordance with another aspect of the invention, there is provided a method for measuring a length of a tree stem being fed through a tree processor attachment, the method comprising: (a) determining by an encoder an indication of the number of revolutions of a measuring wheel of the tree processor attachment while the measuring wheel is in contact with the tree stem; (b) communicating the indication from the encoder to a processor; and (c) determining by the processor a measured length associated with the indication. The method may include displaying the measured length on a display.

In accordance with another aspect of the invention, there is provided a feed roller mechanism for use in a tree processor attachment, the feed roller mechanism comprising: (a) a first-side roller; (b) a second-side roller disposed adjacent to the first-side roller; (c) a bearing having an outer side and an inner side, the bearing being rotatably coupled at its outer side to the first-side roller and being rotatably coupled at its inner side to the second-side roller. The feed roller mechanism may include an outer hub attached to the first-side roller and rotatably coupled to the bearing at its outer side. The outer hub may make rotational contact with the bearing at an angle relative to an axis of rotation of the first-side roller. The feed roller mechanism may include an inner hub attached to the second-side roller and rotatably coupled to the bearing at its inner side. The inner hub may make rotational contact with the bearing at an angle relative to the axis of rotation of the first-side roller. The feed roller mechanism may include a first-side motor for driving the outer hub. The feed roller mechanism may include a second-side motor for driving the inner hub. The first-side roller and the second-side roller may be disposed adjacent to each other so as to be in a non-contacting abutment relationship to each other.

In accordance with another aspect of the invention, there is provided a pin retention mechanism for retaining a pin having a groove adjacent an end of the pin, the mechanism comprising: (a) a two-part collar, each part having a first longitudinal section dimensioned for mating with the groove and a second longitudinal section dimensioned for mating with the end of the pin, at least one of the first and second longitudinal sections being dimensioned for mating to the pin with interference; and (b) a nut for threadedly engaging the collar when the collar is mated to the pin. The first longitudinal section may be associated with a diameter that is less than the diameter of the groove. The second longitudinal section may be associated with a diameter that is less than the diameter of the end of the pin.

Other aspects and features of the present invention will become apparent to those of ordinary skill in the art upon review of the following description of embodiments of the invention in conjunction with the accompanying figures and claims.

### BRIEF DESCRIPTION OF THE DRAWINGS

In drawings which illustrate by way of example only embodiments of the invention:

FIG. 1 is a front view of an apparatus for processing trees, when attached to a forestry vehicle, according to a first embodiment of the invention;

FIG. 2 is a top view of the apparatus of FIG. 1, showing outer feed rollers for gripping a tree;

FIG. 3 is a perspective view of the apparatus of FIG. 1, showing a longitudinal axis defined in relation to a main body of the apparatus;

FIG. 4 is a front view of a saw bar clamping mechanism according to embodiments of the invention, showing the mechanism clamping a saw bar;

FIG. 5 is a cut-away view of a portion of the saw bar clamping mechanism of FIG. 4, showing a cam in its clamping position;

FIG. 6 is a front view of the saw bar clamping mechanism of FIG. 4, showing the saw bar unclamped;

FIG. 7 is a cut-away view of the portion shown in FIG. 5, showing the cam in its unclamped position;

FIG. 8 is a side view of a length measuring mechanism according to embodiments of the invention, showing a measuring wheel slidable along a guide;

FIG. 9 is a schematic diagram of a system for measuring the length of a tree stem according to embodiments of the invention, showing a processor for receiving data from an encoder;

FIG. 10 is front view of a feed roller mechanism, showing an axis of rotation of left-side and right-side rollers;

FIG. 11 is a cut-away view of the feed roller mechanism of FIG. 10, showing an angular contact roller bearing;

FIG. 12 is a side view of the apparatus of FIG. 1, showing a pin and a pin retention system;

FIG. 13 is a side view of the pin shown in FIG. 12, showing lock nuts at opposing ends of the pin;

FIG. 14 is a sectional view of components of the pin retention system shown in FIG. 12, showing two parts of a two-part collar; and

FIG. 15 is a perspective view of one part of the two-part collar shown in FIG. 14, showing a flattened portion of the collar part.

### DETAILED DESCRIPTION

An apparatus for processing trees when attached to a forestry vehicle may include clamping means for clamping a saw bar of the apparatus. The apparatus may include length measuring means for measuring the length of a tree stem. The apparatus may include feed roller means for feeding a stem through the apparatus. The apparatus may include pin retention means for retaining a pin of the apparatus.

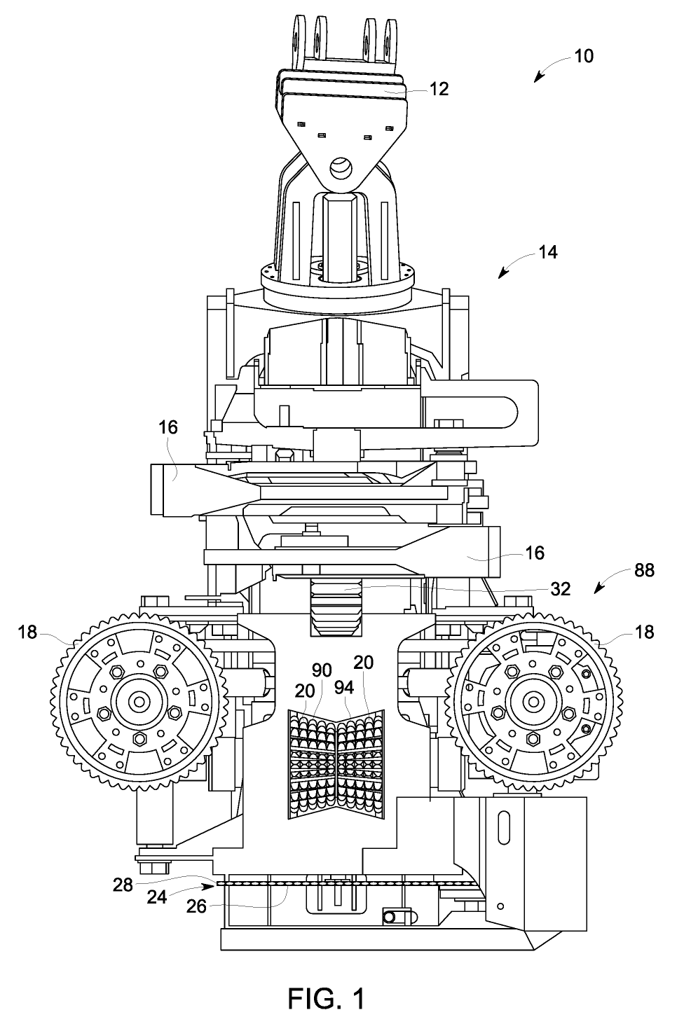

Referring to FIGS. 1 to 3, the apparatus according to a first embodiment of the invention is shown generally at 10. The apparatus 10 is dimensioned for being attached to a forestry harvester at an attachment point 12 of the main body 14 of the apparatus 10. The apparatus 10 functions as a felling head or tree processor attachment.

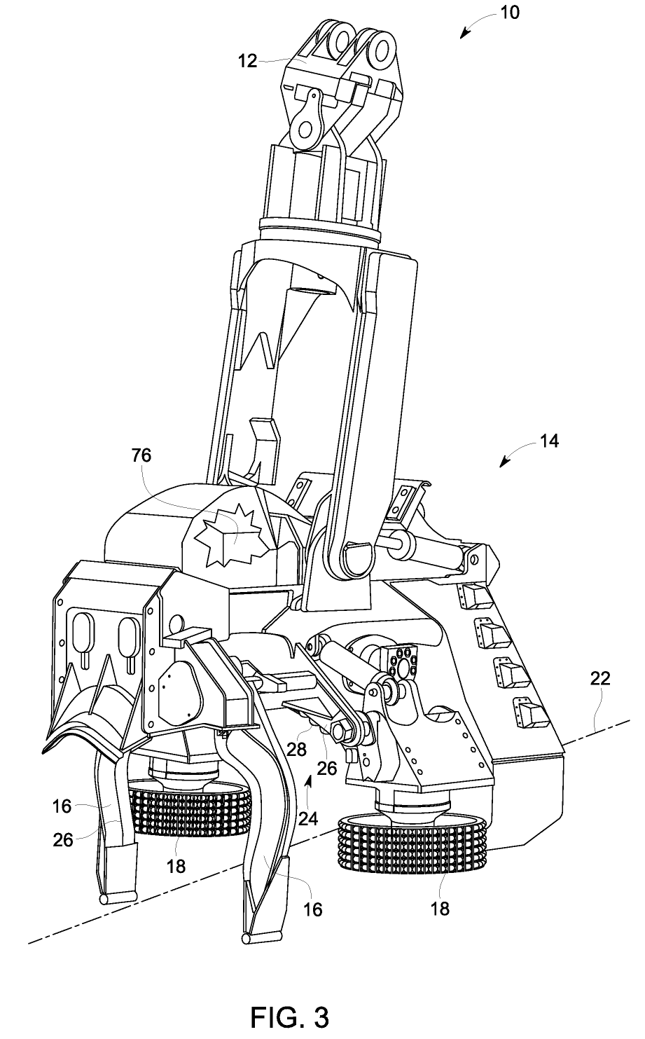

The apparatus 10 includes a pair of delimbing arms 16 described further below. The apparatus 10 also includes a pair of outer feed rollers 18 and a pair of inner feed rollers 20 (best seen in FIG. 1) for gripping a tree (not shown) positioned along the longitudinal axis 22 (best seen in FIG. 3), and for feeding the tree stem (not shown) through the apparatus 10 along the longitudinal axis 22 so as to delimb the tree stem. The longitudinal axis is defined in relation to the main body 14, such as by the relative positions of the outer and inner feed roller 18 and 20, as the axis along which a tree stem is desirably held by the apparatus 10. The apparatus 10 also includes a chain saw 24 for sawing the tree or tree stem. In the first embodiment, the chain saw 24 includes a saw bar 26 and a chain 28.

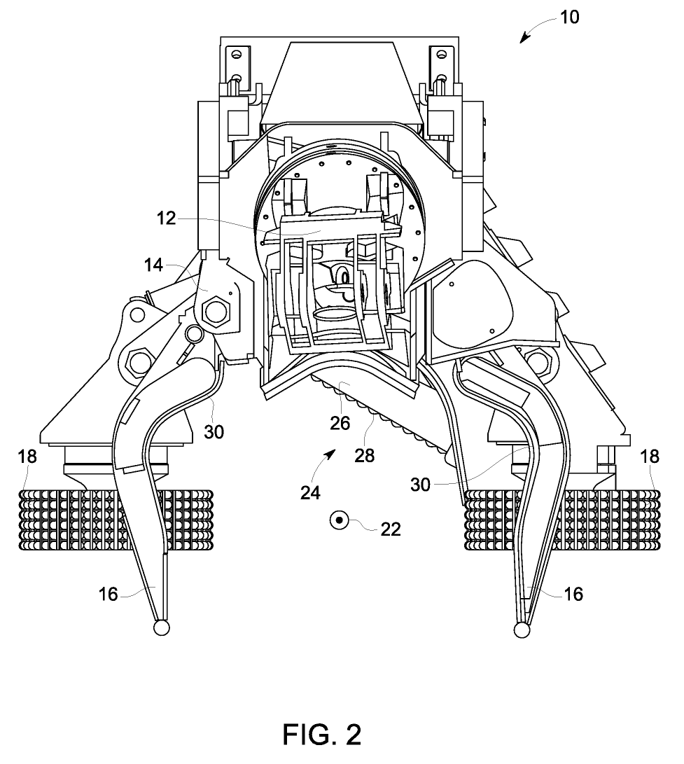

Typically, a standing tree is gripped and sawed with the apparatus 10 in the vertical position, or standing mode, shown in FIGS. 1 and 2; and then the apparatus 10 is moved with the falling tree into the substantially horizontal position, or processing mode, shown in FIG. 3 for delimbing the stem and cutting the stem into logs of desired length. Typically, the inner and outer feed rollers 18 and 20 are bi-directional and can feed the tree stem in either or both directions along the longitudinal axis 22.

In the first embodiment, the delimbing arms 16 include knife blades 30 disposed along respective inner edges of the delimbing arms 16 for delimbing the stem as it is fed through the apparatus 10. In some embodiments, the delimbing arms 16 include multiple knife blades 30 along different edges of the delimbing arms 16 for delimbing the stem in either or both directions through the apparatus 10. In some embodiments, the delimbing arms 16 also assist in gripping the tree and tree stem.

The apparatus 10 includes a measuring wheel 32 (best seen in FIG. 1) for measuring the length of a tree stem as it is fed through the apparatus 10. The apparatus 10 is operable to cause the measuring wheel 32 to make contact with the tree stem, and the measuring wheel 32 is operable to rotate in response to the tree stem being fed through the apparatus 10. While the measuring wheel 32 is in contact with the tree stem, the number of rotations of the measuring wheel 32 indicates the length of tree stem that has been fed through the apparatus 10.

In the first embodiment, the pair of outer feed rollers 18 includes a left outer feed roller 18 and a right outer feed roller 18. Similarly, the inner pair of feed rollers 20 includes a left inner feed roller 20 and a right inner feed roller 20. In the case of simultaneously gripping multiple tree stems (not shown), the left rollers 18 and 20 can be rotated in a direction opposite to the direction of the right rollers 18 and 20, such that different tree stems can be aligned at one end (typically where they had been cut from their tree stumps). The apparatus 10 is operable to move the measuring wheel 32 to make contact with one or more gripped tree stem for simultaneous length measurements as the multiple tree stems are simultaneously fed through the apparatus 10 in one direction.

The chain saw 24 is employed after feeding tree stem(s) through the apparatus 10 to a desired length, to produce log(s) having the desired length.

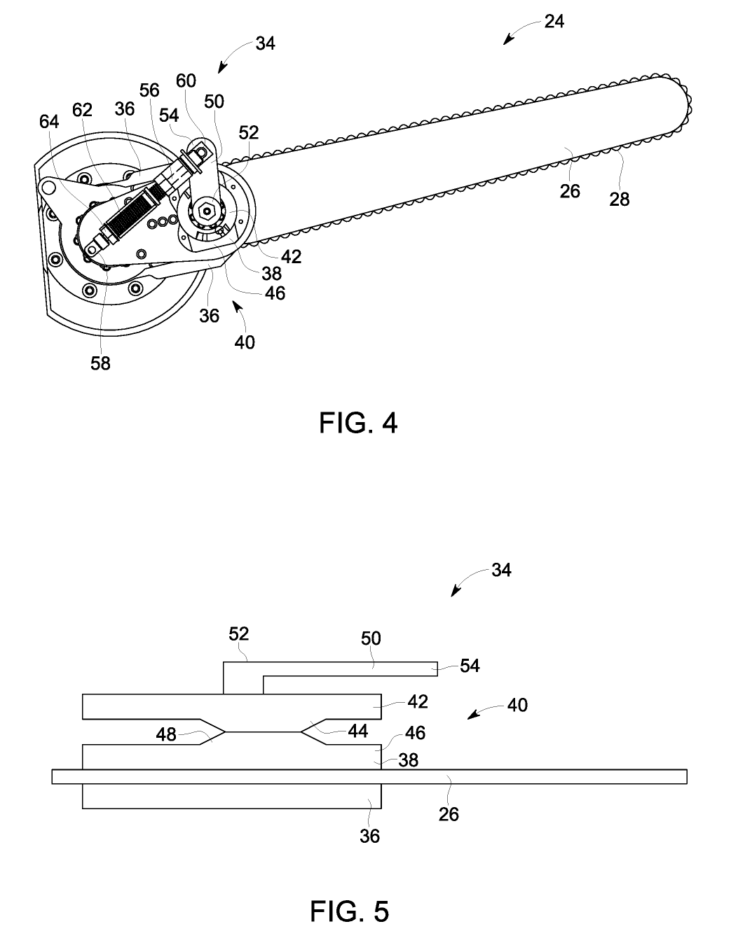

Referring to FIGS. 4 to 7, a saw bar clamping mechanism is shown generally at 34. The apparatus 10 in the first embodiment includes the saw bar clamping mechanism 34. However, the mechanism 34 is also suitable for use in other embodiments and apparatus.

The saw bar clamping mechanism 34 includes a first clamping plate 36 disposed on one side of one end of the saw bar 26; and a second clamping plate 38 disposed on the opposite side of the one end of the saw bar 26. In the first embodiment, the first clamping plate 36 is attached to the main body 14 (FIGS. 1 to 3) and, in a variation, may be integrally attached to the main body 14 or frame thereof.

The saw bar clamping mechanism 34 also includes a cam 40, which comprises a first cam plate 42, having a first-cam lobe 44 (FIGS. 5 and 7) projecting therefrom, and a second cam plate 46, which has a second-cam lobe 48 (FIGS. 5 and 7) projecting therefrom. In the first embodiment, the first and second cam plates 42 and 46 are substantially parallel to each other. In the first embodiment, the second cam plate 46 is the second clamping plate 38.

The second-cam lobe 48 is on the side of the second cam plate 46 that is opposite to the saw bar 26. Thus, in the first embodiment the first-cam lobe 44 and the second-cam lobe 48 face each other. In the first embodiment, when the cam 40 is in its first cam position (FIGS. 4 and 5), the first-cam lobe 44 and the second-cam lobe 48 are aligned with each other and in contact with each other so as to push the second clamping plate 38 into clamping contact with the saw bar 26, thereby clamping the saw bar 26 between the first and second clamping plates 36 and 38. In some embodiments, the cam 40 is operable to lock in its first cam position so as to resist unclamping of the saw bar 26 when the apparatus 10 is subject to routine use and associated vibration. In variations, however, friction between the first and second cam plates 36 and 46 is sufficient to lock the cam 40 in its first cam position.

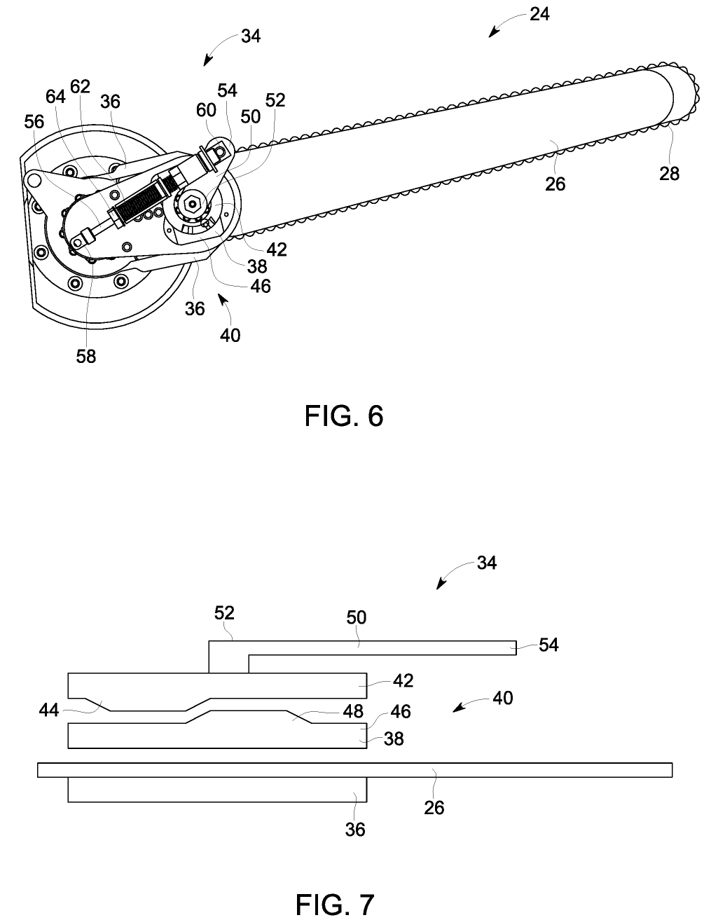

When the cam 40 is in its second cam position (FIGS. 6 and 7), the first-cam lobe 44 and the second-cam lobe 48 are adjacent each other (i.e. not aligned with each other) such that clamping of the saw bar 26 is released. In some embodiments, the cam 40 is operable to retract (i.e. inwardly move) the saw bar 26 when clamping is released. In variations, however, merely releasing the saw bar 26 clamping results in retraction of the saw bar 26, such as due to tension and weight associated with the chain 28 for example.

In the first embodiment, the cam 40 is rotated between its first and second cam positions by applying a tool (not shown) to the cam 40, such as at an outer edge of the first cam plate 42, and rotating the tool. Any suitable tool, such as a bar-like tool (not shown), may be employed for example. In some embodiments, the saw bar mechanism 34 includes a handle (not shown) for rotating the cam 40. The handle may be a removable handle, for example.

Still referring to FIGS. 4 to 7, a first lever 50 is attached at its cam end 52 to the first cam plate 42. The first lever 50 has a second end 54 opposite its cam end 52. In the first embodiment, rotating the first cam plate 42 also rotates the first lever 50, as can be seen by comparing FIG. 4, in which the saw bar 26 is shown clamped, to FIG. 6, in which the saw bar 26 is shown unclamped.

Referring to FIGS. 4 and 6, a resilient lever 56 is pivotally attached at its first end 58 to the main body 14 (FIG. 1), and pivotally attached at its second end 60 to the first lever 50 at its second end 54. In the first embodiment, the resilient lever 56 includes a resilient member such as the spring 62 shown in FIGS. 4 and 6.

As shown in FIG. 4, the resilient lever 56 is operable to cause the saw bar 26 to apply tension to the chain 28 when the cam is at a first cam position in which the saw bar 26 is clamped between the first and second clamping plates 36 and 38. A tension-adjustment member such as the nut 64 abuts the spring 62. Threadedly advancing or threadedly receding the nut 64 along the resilient lever 56 adjusts the tension that the saw bar 26 applies to the chain 28 when the saw bar 26 is being clamped. The nut 64 adjusts the chain 28 tension by adjusting compression of the spring 62.

As shown in FIG. 6, when the saw bar 26 is unclamped, the spring 62 is released from the first end 58 of the resilient lever 56. Thus, rotating the cam 40 from its first cam position to its second cam position advantageously simultaneously unclamps the saw bar 26 and releases tension on the chain 28, such that the saw bar 26 and/or chain 28 can be readily removed from the apparatus 10.

Thus, there is provided a saw bar clamping mechanism for use in a chain saw having a saw bar and a chain, the saw bar clamping mechanism comprising: (a) a pair of clamping plates dimensioned for clamping the saw bar; and (b) a cam having a first cam position in which the saw bar is clamped and applies tension to the chain, and having a second cam position in which the saw bar is unclamped such that tension on the chain is released.

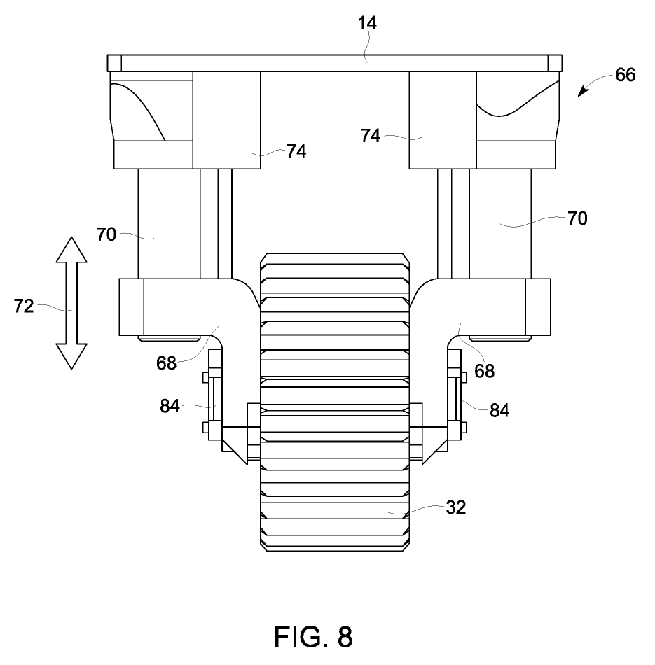

Referring to FIGS. 1, 3 and 8, a length measuring mechanism is shown generally at 66 (FIG. 8). The apparatus 10 in the first embodiment includes the length measuring mechanism 66. However, the mechanism 66 is also suitable for use in other embodiments and apparatus.

The length measuring mechanism 66 includes the measuring wheel 32, which in the first embodiment is rotatably coupled to a wheel support such as the wheel mounts 68 shown in FIG. 8 as being disposed on either side of the measuring wheel 32. In the first embodiment, the wheel mounts 68 are slidably coupled to a pair of guide shafts 70 attached to the main body 14 (FIG. 1) of the apparatus 10. In the first embodiment, the wheel mounts 68 and the measuring wheel 32 can slide in the directions shown by the arrow 72 (FIG. 8) under the control and force of the pair of hydraulic cylinders 74.

Typically, the measuring wheel 32 is employed when the apparatus 10 is in its processing mode (see FIG. 3, for example) such that a tree stem (not shown) gripped by the apparatus 10 is directly below the measuring wheel 32. The measuring wheel 32 is employed by extending the measuring wheel 32 away from the main body 14 downward toward the tree stem until making contact with the tree stem. As shown in FIG. 1, central alignment of the measuring wheel 32 and the inner feed rollers 20 advantageously reduces side loads on the measuring wheel 32 that can occur as the tree stem(s) are fed through the apparatus 10. Also, perpendicular alignment of the guide shafts 70 to the longitudinal axis 22 (FIG. 3) advantageously avoids pivoting engagement of the measuring wheel 32 to the gripped tree stem.

The length measuring mechanism 66 includes a hydraulic fluid pressure control system that includes the accumulator 76 shown by cut-out in FIG. 3. The accumulator 76 is a container that is in fluid communication with the hydraulic cylinders 74 to absorb and release hydraulic fluid, thereby ensuring that the measuring wheel 32 makes contact with the tree stem(s) at a relatively constant pressure while advantageously permitting the measuring wheel 32 to extend and retract along contours of the tree stem(s) as it is fed through the apparatus 10. The linear extension and retraction motion of the measuring wheel 32 advantageously avoids any longevity and reliability issues that would be introduced by a pivoting motion of the measuring wheel 32.

Thus, there is provided a length measuring mechanism for use in a tree processor attachment, the tree processor attachment being operable to grip a tree stem along a longitudinal axis defined in relation to a main body of the tree processor attachment, the length measuring mechanism comprising: (a) a guide projecting from the main body substantially perpendicularly to the longitudinal axis; (b) a wheel support slidably coupled to the guide; and (c) a measuring wheel rotatably coupled to the wheel support.

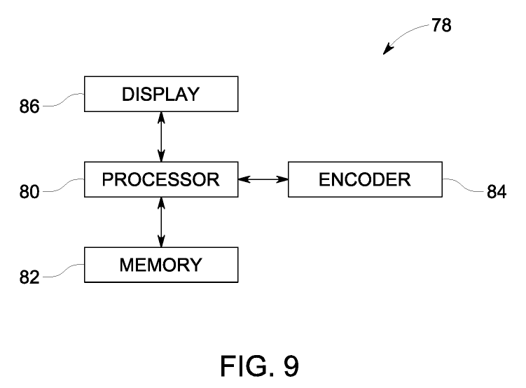

Referring to FIGS. 8 and 9, a system for measuring the length of a tree stem is shown generally at 78. The apparatus 10 in the first embodiment includes the length measuring system 78. However, the system 78 is also suitable for use in other embodiments and apparatus.

The length measuring system 78 includes a processing circuit, such as the processor 80 shown in FIG. 9, and a memory circuit, such as the memory 82 shown in FIG. 9.

The processor 80 in variations can include any number of circuit units, such as a central processing unit (CPU), digital signal processor (DSP), embedded processor, etc., and any combination thereof operating independently or in parallel, including possibly operating redundantly. The processor 80 may be implemented by one or more integrated circuits (IC), including being implemented by a monolithic integrated circuit (MIC), an Application Specific Integrated Circuit (ASIC), a Field Programmable Gate Array (FPGA), programmable logic controller (PLC), etc. or any combination thereof. The processor 80 may include circuitry for storing memory, such as digital data, and may comprise the memory 82 or be in wired or wireless communication with the memory 82, for example. The processor 80 may constitute or form part of any computing device such as a general purpose computer, microcomputer, minicomputer, mainframe computer, distributed network for computing, functionally equivalent discrete hardware components, etc. and any combination thereof, for example.

The memory 82 in the first embodiment is operable to store digital representations of data or other information, including measurement results and/or control information, and to store digital representations of program data or other information, including program code for directing operations of the processor 80. In variations, the memory 82 may be all or part of a digital electronic integrated circuit or formed from a plurality of digital electronic integrated circuits. The memory 82 may be implemented as Read-Only Memory (ROM), Programmable Read-Only Memory (PROM), Erasable Programmable Read-Only Memory (EPROM), Electrically Erasable Programmable Read-Only Memory (EEPROM), flash memory, one or more flash drives, universal serial bus (USB) connected memory units, magnetic storage, optical storage, magneto-optical storage, etc. or any combination thereof, for example. The memory 82 may be operable to store digital representations as volatile memory, non-volatile memory, dynamic memory, etc. or any combination thereof.

Still referring to FIGS. 8 and 9, the length measuring system 78 includes at least one encoder 84 for electronically counting the number of revolutions of the measuring wheel 32, and/or fractions of revolutions thereof. In the first embodiment, the encoder 84 is in electronic communication, which in variations may be wired and/or wireless communication, with the processor 80. The encoder 84 in the first embodiment is operable to communicate an indication of the number of revolutions of the measuring wheel 32 to the processor 80; the processor 80 is operable to determine a measured length associated with the received indication; and the processor 80 is operable to display the measured length on a display 86. In variations, however, either or both of the processor 80 and the encoder 84 may be operable to determine the measured length. The display 86 may be located in a cab of the forestry vehicle carrying the apparatus 10, for example. However, in variations the display 86 may be found at any suitable location and may be omitted entirely from the system 78, for example.

In the first embodiment, when electrical power is being supplied to the processor 80 and the memory 82, the processor 80 is directed by codes stored in the memory 82 to receive the indication from the encoder 84, and to determine the measured length in response to the received indication. In the first embodiment, the processor 80 is also directed to display the measured length on the display 86.

Thus, there is provided a method for measuring a length of a tree stem being fed through a tree processor attachment, the method comprising: (a) determining by an encoder an indication of the number of revolutions of a measuring wheel of the tree processor attachment while the measuring wheel is in contact with the tree stem; (b) communicating the indication from the encoder to a processor; and (c) determining by the processor a measured length associated with the indication.

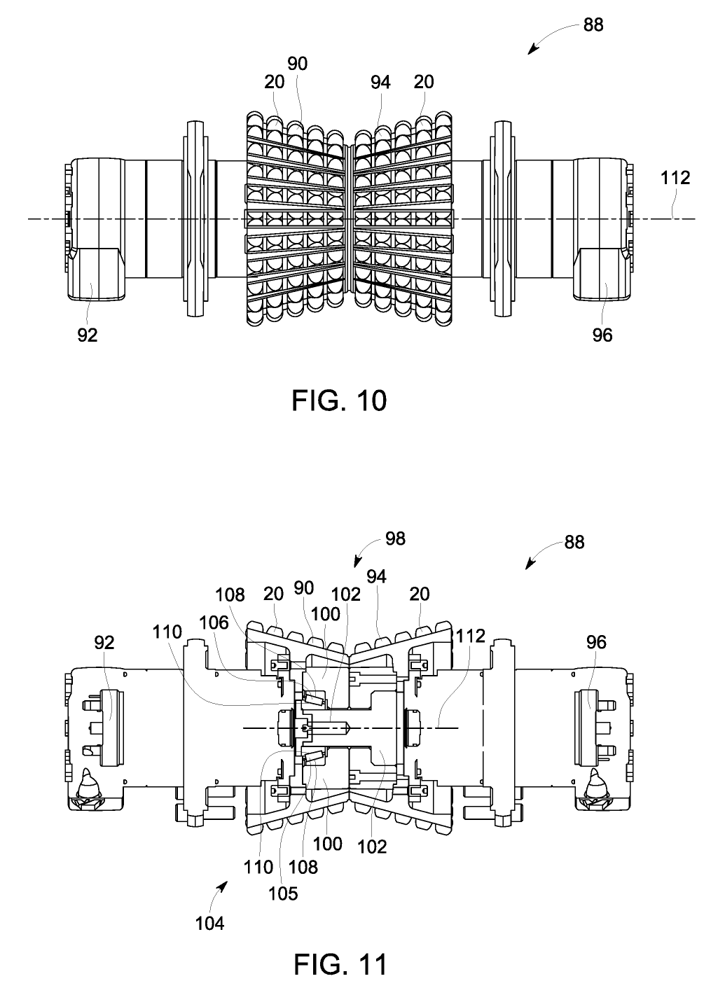

Referring to FIGS. 1, 10 and 11, a feed roller mechanism for moving a tree stem is shown generally at 88. The apparatus 10 in the first embodiment includes the feed roller mechanism 88. However, the mechanism 88 is also suitable for use in other embodiments and apparatus.

The feed roller mechanism 88 includes the inner feed rollers 20, which in the first embodiment includes a left-side roller 90 driven by a left-side motor 92 and a right-side roller 94 driven by a right-side motor 96. In the first embodiment, the motors 92 and 96 are hydraulic motors that are typically powered by the forestry vehicle carrying the apparatus 10.

In general, the left-side roller 90 and the right-side roller 94 may be separated from each other by any suitable distance, including being separated by a distance less than 10 cm (3.94″) for example. In the first embodiment, the separation between the left-side roller 90 and the right-side roller 94 is in the range of 1.02 mm (0.040″) to 1.52 (0.060″), and may be 1.27 mm (0.050″).

Referring to FIG. 11, the feed roller mechanism 88 in the first embodiment includes a two-part hub 98 having an outer hub member 100 attached between the left-side roller 90 and the left-side motor 92, and having an inner hub member 102 attached between the right-side roller 94 and the right-side motor 96. The feed roller mechanism 88 also includes in the first embodiment a bearing such as the angular contact roller bearing 104 shown in FIG. 11. The bearing 104 includes rollers 106 defining an outer-contact side 108 and an inner-contact side 110 of the bearing 104.

In the first embodiment, the outer hub member 100 is driven by the left-side motor 92, makes rotational contact with the bearing 104 at its outer-contact side 108, and drives the left-side roller 92. Conversely, the inner hub member 102 is driven by the right-side motor 96, makes rotational contact with the bearing 104 at its inner-contact side 110, and drives the right-side roller 94.

In the first embodiment and as shown in FIG. 11, the bearing 104 makes contact with the hub 98 at an angle relative to the axis 112 of rotation of the feed rollers 90 and 94. In general, this bearing 104 contact angle can be any suitable angle, such as any angle greater than zero degrees and less then ninety degrees. In the first embodiment, this bearing 104 contact angle is in the range between 5 and 25 degrees. In some embodiments, this bearing 104 contact angle is in the range between 10 and 20 degrees. This bearing 104 contact angle may be 15 degrees, for example. This bearing 104 contact angle advantageously provides side-load support to the feed rollers 90 and 94, thereby enhancing longevity and reliability of the feed roller mechanism 88.

Thus, there is provided a feed roller mechanism for use in a tree processor attachment, the feed roller mechanism comprising: (a) a first-side roller; (b) a second-side roller disposed adjacent to the first-side roller; (c) a bearing having an inner side and an outer side, the bearing being rotatably coupled at its inner side to the first-side roller and being rotatably coupled at its outer side to the second-side roller, the bearing making angular contact with the first-side and second-side rollers.

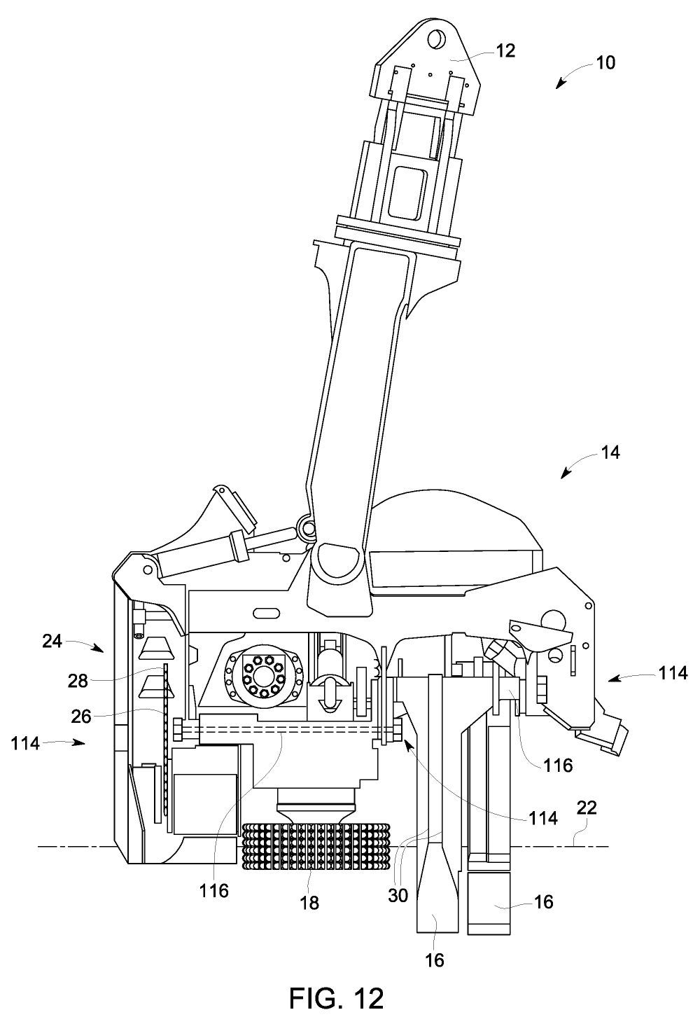

Referring to FIG. 12, a pin retention mechanism for retaining a pin is shown generally at 114. The apparatus 10 in the first embodiment includes the pin retention mechanism 114. However, the mechanism 114 is also suitable for use in other embodiments and apparatus.

Referring to FIGS. 12 to 14, the pin retention mechanism 114 functions to retain a pin, such as the pins 116 employed in the first embodiment to rotatably couple the delimbing arms 16 and each of the outer feed rollers 18 to the main body 14 of the apparatus 10, when the pin 116 is fastened to the main body 14 of the apparatus 10 (FIG. 12). FIG. 14 by dotted line shows portions of the main body 14, which in this exemplary drawing represent flanges of a frame of the main body 14. Other uses of a given pin 116 are possible.

As best seen in FIG. 14, the pin 116 includes a mid-section 118 separated from opposing pin ends 120 by grooves 122. The mid-section 118 may have any suitable length, indicated by break lines in FIG. 14. In the first embodiment, the mid-section 118 and the pin ends 120 have circular cross-sections, while the cross-sectional shape of the groove 122 includes flattened faces 124 on opposing sides of each other.

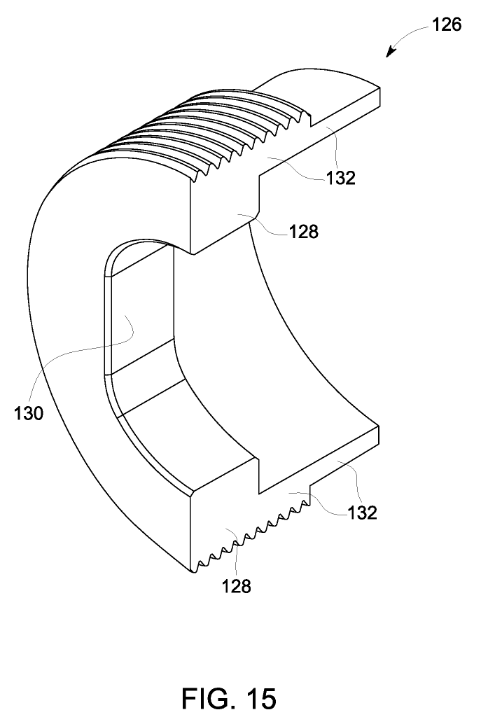

Referring to FIGS. 14 and 15, the pin retention mechanism 114 of the first embodiment includes a two-part collar 126. The two collar 126 parts are dimensioned for alignment with each other when disposed around one groove 122 and its adjacent pin end 120 of the pin 116. Each collar 126 part includes a first longitudinal section 128 having a flattened portion 130 that is dimensioned to fit against one flattened face 124 of the groove 122 of the pin 116. Each collar 126 part also includes a second longitudinal section 132 that is dimensioned to fit against the pin end 120.

In one embodiment, the inside diameter generally associated with the second longitudinal section 132 is slightly smaller than the diameter of the pin end 120. In this embodiment, the interference between the respective diameters of the second longitudinal section 132 and the pin end 120 is less than 0.5 mm (0.020″) and may be in the range of 0.10 mm (0.004″) and 0.15 mm (0.006″), for example. Also in this embodiment, the inside diameter associated with the first longitudinal section 128 is no smaller than the diameter of the groove 122 and, in some embodiments may be slightly larger so as to form a small gap between the first longitudinal section 128 and the groove 122 when the collar 126 is mated to the pin 116 at its groove 122 and pin end 120.

In another embodiment, the inside diameter generally associated with the first longitudinal section 128 is slightly smaller than the diameter of the groove 122. In this embodiment, the interference between the respective diameters of the first longitudinal section 128 and the groove 122 is less than 0.5 mm (0.020″) and may be in the range of 0.10 mm (0.004″) and 0.15 mm (0.006″), for example.

Also in this embodiment, the inside diameter associated with the second longitudinal section 132 is no smaller than the diameter of the pin end 120 and, in some embodiments may be slightly larger so as to form a small gap between the second longitudinal section 132 and the pin end 120 when the collar 126 is mated to the pin 116 at its groove 122 and pin end 120.

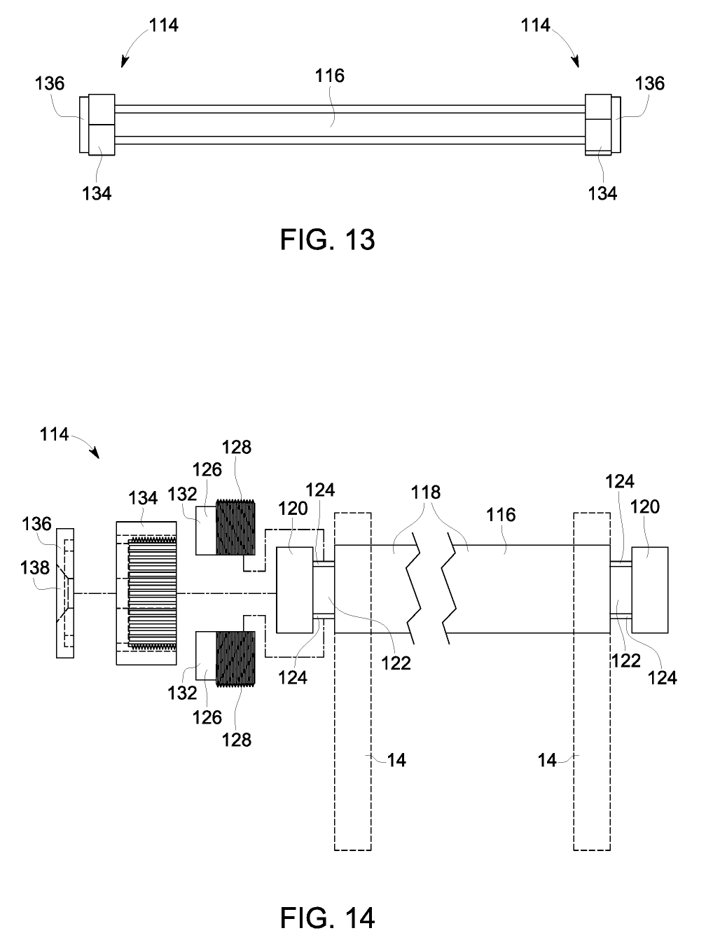

Referring to FIGS. 13 and 14, the pin retention mechanism 114 includes a lock nut 134 dimensioned to threadedly engage the collar 126 parts after the collar 126 has been mated to the pin 116. The lock nut 134 includes inwardly facing threads dimensioned for engaging the outwardly facing threads of the collar 126 parts. The interference between the collar 126 parts and pin 116 advantageously maintains the lock nut 134 in place after it has been threaded onto the collar 126 by forcing a slight incline and/or pivoting of the collar 126 parts against the pin 116.

The flattened faces 124 of the groove 122 and the corresponding flattened portions 130 of the collar 126 parts advantageously inhibit rotation of the collar 126 about the pin 116 when the lock nut 134 is threaded onto the collar 126, thereby further maintaining the lock nut 134 in place. While the Figures show two flattened faces 124 in each groove 122 and one flattened portion 130 in each collar 126 part, in general any suitable number of flattened faces and portions may be employed. Typically, the number of flattened faces 124 in each groove 122 is the same as the total number of flattened portions 130 in each collar 126. In general, the flattened faces 124 and flattened portions 130 are optional and some embodiments do not include any flattened faces 124 and do not include any flattened portions 130.

The pin retention mechanism 114 optionally includes a protective cap 136 and a cap bolt 138 (a portion of which is shown in dotted line in FIG. 14) for fastening the protective cap 136 onto the pin end 120. The protective cap 136 is typically fastened onto the pin end 120, after installing the lock nut 134 over the collar 126, by threadedly engaging the cap bolt 138 into the pin end 120. The pin end 120 typically includes a threaded bore (not visible in the Figures) for receiving the cap bolt 138. Fastening the protective cap 136 advantageously protects the pin retention mechanism 114 against damage from any inadvertent or intentional impacts, and can be made aesthetically pleasing.

Thus, there is provided a pin retention mechanism for retaining a pin having a groove adjacent an end of the pin, the mechanism comprising: (a) a two-part collar, each part having a first longitudinal section dimensioned for mating with the groove and a second longitudinal section dimensioned for mating with the end of the pin, at least one of the first and second longitudinal sections being dimensioned for mating to the pin with interference; and (b) a nut for threadedly engaging the collar when the collar is mated to the pin.

While embodiments of the invention have been described and illustrated, such embodiments should be considered illustrative of the invention only. The invention may include variants not described or illustrated herein in detail. Thus, the embodiments described and illustrated herein should not be considered to limit the invention as construed in accordance with the accompanying claims.

1. An apparatus for processing trees when attached to a forestry vehicle, each of the trees having a tree stem, the apparatus having a main body and further comprising
a chain saw for cutting the trees, the chain saw comprising a saw bar, a chain and a saw bar clamping mechanism for clamping the saw bar, the saw bar clamping mechanism comprising a cam slidably coupled to the saw bar and rotatable between a first cam position and a second cam position different from the first cam position, the saw bar applying tension to the chain when the cam is at its first cam position and not applying the tension when the cam is at its second cam position.

2. The apparatus of claim 1 wherein the saw bar clamping mechanism comprises a pair of clamping plates dimensioned to clamp the saw bar, the cam causing the clamping plates to clamp the saw bar when the cam is at its first position.

3. The apparatus of claim 2 wherein the cam is dimensioned to cause the clamping plates to unclamp the saw bar when the cam is at its second cam position.

4. The apparatus of claim 1 wherein the saw bar clamping mechanism comprises a first lever attached to the cam and a second lever attached between the first lever and the main body, the second lever comprising a resilient member.

5. The apparatus of claim 4 wherein the second lever comprises a tension-adjustment member operable to adjust the tension that is applied when the cam is at its first cam position.

6. The apparatus of claim 4 further comprising a handle for actuating the second lever.

7. The apparatus of claim 1 further comprising a length measuring mechanism for measuring the length of the tree stem.

8. The apparatus of claim 7 wherein the length measuring mechanism comprises a wheel support, a measuring wheel rotatably coupled to the wheel support, and a linear actuator operable to cause the wheel support to extend outwardly from the main body in accordance with a pre-determined force.

9. The apparatus of claim 8 wherein the apparatus defines a longitudinal axis, the apparatus being operable to grip the tree stem along the longitudinal axis, the length measuring mechanism comprising a guide projecting from the main body perpendicularly to the longitudinal axis, the wheel support being slidably coupled to the guide.

10. The apparatus of claim 8 further comprising an encoder for producing a count of the number of rotations of the measuring wheel.

11. The apparatus of claim 1 further comprising a feed roller mechanism for feeding the tree stem through the apparatus.

12. The apparatus of claim 11 wherein the feed roller mechanism comprises a first-side roller and a second-side roller, the first-side and second-side rollers being disposed adjacent to each other so as to be in a non-contacting abutment relationship to each other.

13. The apparatus of claim 12 wherein the feed roller mechanism comprises a bearing having an outer side and an inner side, the bearing being rotatably coupled at its outer side to the first-side roller and being rotatably coupled at its inner side to the second-side roller.

14. The apparatus of claim 13 wherein the feed roller mechanism comprises an outer hub and an inner hub, the outer hub being attached to the first-side roller and rotatably coupled to the bearing at its outer side, the inner hub being attached to the second-side roller and rotatably coupled to the bearing at its inner side.

15. The apparatus of claim 14 wherein the feed roller mechanism defines an axis of rotation associated with the first-side and second-side rollers, the bearing rotationally contacting the outer hub and the inner hub at an angle relative to the axis of rotation.

16. The apparatus of claim 1 comprising a pin having a pin end and a groove adjacent the pin end, the apparatus further comprising a pin retention mechanism for retaining the pin, the pin retention mechanism comprising a two-part collar comprising a first collar part and a second collar part, each said collar part comprising a first longitudinal section dimensioned for mating with the groove and a second longitudinal section dimensioned for mating with the pin end.

17. The apparatus of claim 16 wherein the pin retention mechanism comprises a nut for threadedly engaging the two-part collar when the two-part collar is mated to the pin at the pin end.

18. A method for measuring a length of a tree stem being fed through a tree processor attachment attached to a forestry vehicle, the tree processor attachment having a main body, a computerized processor and a memory, the method comprising:
(a) determining by an encoder an indication of the number of revolutions of a measuring wheel rotatably coupled to a wheel support extending outwardly from the main body in accordance with a pre-determined force when the measuring wheel is in contact with the tree stem;
(b) communicating the indication from the encoder to the computerized processor; and
(c) determining by the computerized processor a measured length associated with the indication.

19. The method of claim 18 further comprising displaying the measured length on a display associated with the forestry vehicle.

20. A tree processor attachment apparatus for processing trees when attached to a forestry vehicle, each of the trees having a tree stem, the apparatus comprising:
(a) clamping means for clamping a saw bar of the apparatus;
(b) length measuring means for measuring the length of the tree stem;
(c) feed roller means for feeding the tree stem through the apparatus; and
(d) pin retention means for retaining a pin of the apparatus.
